(19) United States
(12) Patent Application Publication
(10) Pub. No.: US 2021/0301870 A1
(43) Pub. Date: Sep. 30, 2021

(54) SUBSTRATE HOLDER FOR USE WITH INTERFEROMETER

(71) Applicant: CORNING INCORPORATED, Corning, NY (US)

(72) Inventor: Ronnie Rex Fesperman, JR., Statesville, NC (US)

(21) Appl. No.: 17/206,800

(22) Filed: Mar. 19, 2021

Related U.S. Application Data
(60) Provisional application No. 63/000,834, filed on Mar. 27, 2020.

(51) Int. Cl. F16C 32/06; G01B 9/02

(52) U.S. Cl. CPC F16C 32/0614; G01J 2009/0292; G01B 9/02015; G01B 9/02049

(57) ABSTRACT

A substrate holder for use with an interferometer comprises a first and second support each comprising a bearing land and a bearing base arranged to form a bearing pocket and a gas inlet fluidly coupled to the bearing pocket. The first support and the second support are positioned relative to one another such that the first bearing pocket is opposed to the second bearing pocket thereby forming a measurement cavity between the first support and the second support. At least one of the first support and the second support comprises reference optics through which one or more interferometric or optical measurements can be taken. Gas supplied to the first bearing pocket and gas supplied to the second bearing pocket form an air bearing in the measurement cavity for supporting a substrate in the measurement cavity without contact between the substrate, the first support, and the second support.

### CROSS-REFERENCE TO RELATED APPLICATIONS

This application claims the benefit of priority under 35 U.S.C. § 119 of U.S. Provisional Application Ser. No. 63/000,834 filed on Mar. 27, 2020, the content of which is relied upon and incorporated herein by reference in its entirety.

### FIELD

The present specification generally relates to substrate holders and, more particularly, to substrate holders for use in optical metrology instruments.

### BACKGROUND

In interferometry, highly precise surface measurement is obtained for various types of optical components using interference fringes that are generated between light reflected from a reference surface and light from a surface under test. The Fizeau interferometer is an instrument of this type that can be used to measure various optical surfaces, particularly spherical or planar surfaces having relatively large diameters.

Specifically, Fizeau interferometers can be configured to enable a substrate to be simultaneously imaged and measured from its front and back surfaces, although the amount of the substrate's surface that can be measured at once is limited by the stabilization and fixturing of the substrate. Some conventional fixturing methods contact the substrate on the front and/or back surfaces, reducing the area of the substrate's surface available for measurement. Additionally or alternatively, conventional fixturing methods may not sufficiently stabilize the substrate, which can lead to uncertainty in the measurements.

Accordingly, a need exists for a substrate holder for use with an interferometer that stabilizes and fixtures the substrate without contacting the front and back surfaces of the substrate.

### SUMMARY

Various embodiments described herein enable stabilization and fixturing of a substrate without contacting the first and second side surfaces of the substrate by providing a substrate holder comprising a first support and a second support. The first support comprises a first bearing land and a first bearing base arranged to form a first bearing pocket, and the second support comprises a second bearing land and a second bearing base arranged to form a second bearing pocket. The first and second supports are positioned relative to one another such that the first bearing pocket is opposed to the second bearing pocket, thereby forming a measurement cavity between the first and second supports. Gas is supplied to the first bearing pocket and the second bearing pocket to form an air bearing in the measurement cavity for supporting the substrate in the measurement cavity without contact between the substrate, the first support, and the second support.

According to a first aspect disclosed herein, a substrate holder for use with an interferometer comprises: a first support comprising a first bearing land and a first bearing base arranged to form a first bearing pocket and a first gas inlet fluidly coupled to the first bearing pocket; and a second support comprising a second bearing land and a second bearing base arranged to form a second bearing pocket and a second gas inlet fluidly coupled to the second bearing pocket, wherein: the first support and the second support are positioned relative to one another such that the first bearing pocket is opposed to the second bearing pocket thereby forming a measurement cavity between the first support and the second support; at least one of the first support and the second support comprises reference optics through which one or more interferometric or optical measurements can be taken; and gas supplied to the first bearing pocket and gas supplied to the second bearing pocket form an air bearing in the measurement cavity for supporting a substrate in the measurement cavity without contact between the substrate, the first support, and the second support.

According to a second aspect disclosed herein, a substrate holder comprises the substrate holder according to the first aspect, wherein at least one of the first gas inlet and the second gas inlet comprises a porous medium.

According to a third aspect disclosed herein, a substrate holder comprises the substrate holder according to the second aspect, wherein the porous medium is disposed within the corresponding first or second bearing land.

According to a fourth aspect disclosed herein, a substrate holder comprises the substrate holder according to the second or third aspects, wherein the porous medium is disposed within the corresponding first or second bearing pocket.

According to a fifth aspect disclosed herein, a substrate holder comprises the substrate holder according to the first aspect, wherein at least one of the first gas inlet and the second gas inlet comprises one or more discrete bores in the corresponding first or second support.

According to a sixth aspect disclosed herein, a substrate holder comprises the substrate holder according to the fifth aspect, wherein the one or more discrete bores open into the corresponding first or second bearing land.

According to a seventh aspect disclosed herein, a substrate holder comprises the substrate holder according to the fifth or sixth aspects, wherein the one or more discrete bores open into the corresponding first or second bearing base.

According to an eighth aspect disclosed herein, a substrate holder comprises the substrate holder according to any of the preceding aspects, further comprising a wafer holder positioned within the measurement cavity and coupled to at least one of the first support and the second support.

According to a ninth aspect disclosed herein, a substrate holder comprises the substrate holder according to any of the preceding aspects, wherein the first support and the second support comprise reference optics through which one or more interferometric or optical measurements can be taken.

According to a tenth aspect disclosed herein, a substrate holder comprises the substrate holder according to any of the preceding aspects, wherein the reference optics comprise Fizeau elements.

According to an eleventh aspect disclosed herein, a substrate holder comprises the substrate holder according to any of the preceding aspects, wherein the gas flowing through the first gas inlet provides a first pressure force in the first bearing pocket, the gas flowing through the second gas inlet provides a second pressure force in the second bearing pocket, and the first pressure force is different from the second pressure force.

According to a twelfth aspect disclosed herein, a substrate holder comprises the substrate holder according to the eleventh aspect, wherein the difference between the first pressure force and the second pressure force stiffens a substrate positioned between the first air bearing and the second air bearing.

According to a thirteenth aspect disclosed herein, an interferometer comprises the substrate holder according to any preceding aspect.

According to a fourteenth aspect disclosed herein, an interferometer comprises the interferometer according to the thirteenth aspect, wherein the interferometer makes measurements through one of the first and second supports.

According to a fifteenth aspect disclosed herein, an interferometer comprises the interferometer according to the thirteenth or fourteenth aspects, wherein the interferometer is a compound interferometer and makes measurements through the first and second supports.

According to a sixteenth aspect disclosed herein, a method comprises: positioning a substrate within a substrate holder, the substrate holder comprising: a first support comprising a first bearing land and a first bearing base arranged to form a first bearing pocket and a first gas inlet coupled to the first bearing pocket; and a second support comprising a second bearing land and a second bearing base arranged to form a second bearing pocket and a second gas inlet fluidly coupled to the second bearing pocket; wherein: the first support and the second support are positioned relative to one another such that the first bearing pocket is opposed to the second bearing pocket thereby forming a measurement cavity between the first support and the second support; at least one of the first support and the second support comprises reference optics through which one or more interferometric or optical measurements can be taken; supplying gas to the first bearing pocket and the second bearing pocket to form an air bearing in the measurement cavity for supporting the substrate in the measurement cavity without contact between the substrate, the first support, and the second support; and making one or more interferometric or optical measurements through the first support, the second support, or the first and second supports.

According to a seventeenth aspect, a method comprises the method of the sixteenth aspect, wherein the gas flowing through the first gas inlet provides a first pressure force in the first bearing pocket, the gas flowing through the second gas inlet provides a second pressure force in the second bearing pocket, and the first pressure force is different from the second pressure force.

According to an eighteenth aspect, a method comprises the method of the seventeenth aspect, wherein the difference between the first pressure force and the second pressure force stiffens the substrate.

According to a nineteenth aspect, a method comprises the method of any of the sixteenth through eighteenth aspects, wherein the first support and the second support comprise reference optics, and wherein making the one or more interferometric or optical measurements comprises making the one or more interferometric or optical measurements through the reference optics.

According to a twentieth aspect, a method comprises the method of any of the sixteenth through nineteenth aspects, wherein the reference optics comprise Fizeau elements.

Additional features and advantages will be set forth in the detailed description, which follows, and in part will be readily apparent to those skilled in the art from that description or recognized by practicing the embodiments described herein, including the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A is a diagram of a compound interferometer including a substrate holder according to one or more embodiments shown and described herein;

FIG. 1B is a diagram of the substrate holder depicting multiple reflections for producing interference patterns within a measurement cavity within the substrate holder according to one or more embodiments shown and described herein;

FIG. 2A is a cross-sectional view of a substrate holder including reference optics in the supports according to one or more embodiments shown and described herein;

FIG. 2B is a cross-sectional view of a substrate holder in which the supports include apertures for coupling the supports to reference optics according to one or more embodiments shown and described herein;

FIG. 3A is a top view of an optical reference that can form a support of a substrate holder according to one or more embodiments shown and described herein;

FIG. 3B is a cross-sectional view of the substrate holder of FIG. 3A;

FIG. 4A is a cross-sectional view of a substrate holder in which the gas inlets comprise porous media according to one or more embodiments shown and described herein;

FIG. 4B is a cross-sectional view of another substrate holder in which the gas inlets comprise porous media according to one or more embodiments shown and described herein;

FIG. 5 is a cross-sectional view of a substrate holder in which a differential in gas pressure force deforms the substrate according to one or more embodiments shown and described herein; and

FIG. 6 is a top view of a substrate holder having the first support removed to depict a wafer holder according to one or more embodiments shown and described herein.

### DETAILED DESCRIPTION

Reference will now be made in detail to various embodiments of substrate holders and interferometers comprising the same, examples of which are illustrated in the accompanying drawings. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply ab solute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The term “formed from” can mean one or more of comprises, consists essentially of, or consists of. For example, a component that is formed from a particular material can comprise the particular material, consist essentially of the particular material, or consist of the particular material.

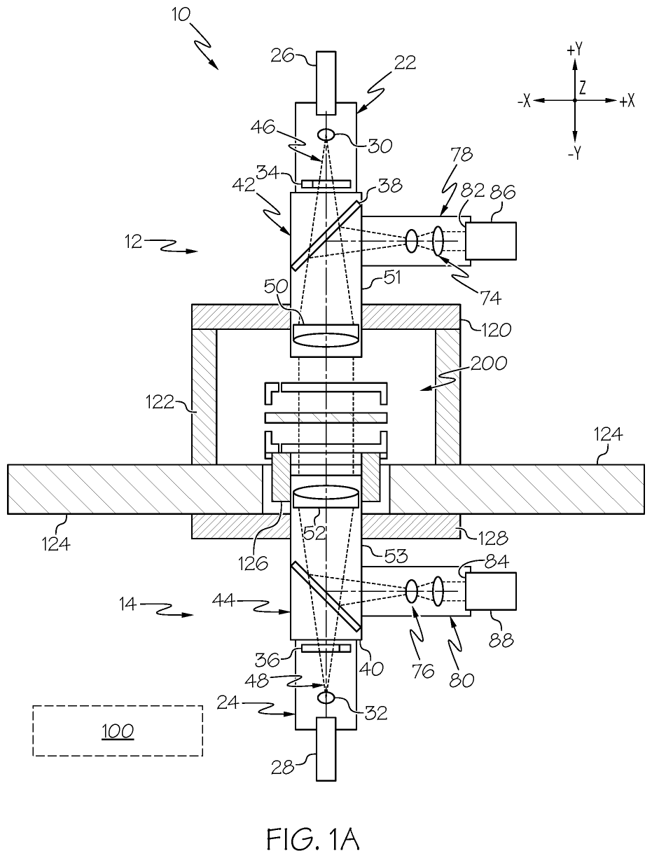

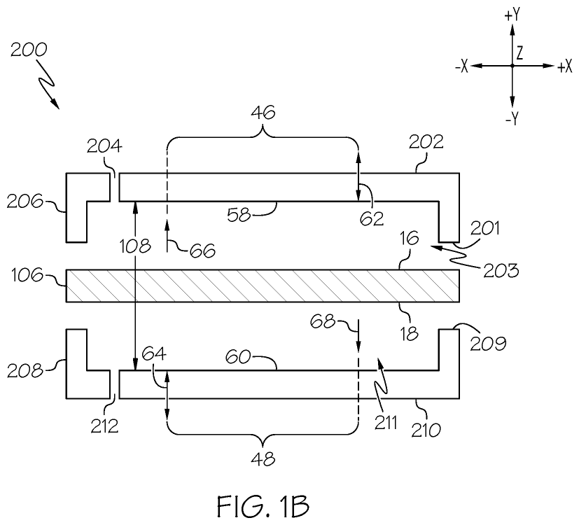

FIG. 1A depicts an interferometer 10 according to various embodiments. The interferometer 10 in FIG. 1A is a compound interferometer which includes an upper interferometer 12 and a lower interferometer 14 for measuring opposite first and second side surfaces 16 and 18 of a substrate 106. Although FIG. 1A depicts the interferometer 10 as a compound interferometer that is configured to measure the first and second side surfaces 16 and 18 of the substrate 106, other types of interferometers, including a single interferometer which measures a single side of the substrate 106, are contemplated. It is contemplated that the interferometer 10 can be used to measure any opaque test part (i.e., substrate 106) that is made of materials that are not transmissive within the range of frequencies propagated by the interferometers 12 and 14, or that is sufficiently diffuse to preclude the ordered transmissions of such frequencies.

The upper and lower interferometers 12 and 14 include respective first and second illuminators 22 and 24, which can include customary light sources 26 and 28 and beam shapers 30 and 32 for outputting coherent first and second measuring beams 46 and 48. For example, the light sources 26 and 28 can be semiconductor diode lasers, and the beam shapers 30 and 32 can include beam expanders and conditioners for affecting distributions of light within the measuring beams 46 and 48.

Within respective upper and lower interferometers 12 and 14, the first and second measuring beams 46 and 48 propagate through first and second shutters 34 and 36 to first and second beam splitters 38 and 40, where the first and second measuring beams 46 and 48 are directed (e.g., transmitted) into first and second measurement arms 42 and 44. Opening and closing of the first and second shutters 34 and 36 can be coordinated by a common processor/controller 100 for alternately blocking the propagation of one or the other of the first and second measuring beams 46 and 48 to prevent light from one interferometer 12 or 14 from mixing with the light from the other interferometer 14 or 12. The first and second beam splitters 38 and 40 can take the form of pellicle beam splitters, beam splitter cubes, or beam splitter plates based on splitting amplitude or polarization.

The measurement arms 42 and 44 include dual functioning optics 50 and 52 within housings 51 and 53, which contribute to both illuminating and imaging the substrate 106. The illuminating function of the dual optics 50 and 52 generally provides for sizing and shaping respective wavefronts of the measuring beams 46 and 48 to nominally match the shapes of the opposite side surfaces 16 and 18 of the substrate 106.

As shown in FIG. 1B, the first and second measurement arms 42 and 44 also include first and second supports 206 and 208 which include reference optics (e.g., Fizeau wedges) having first and second reference surfaces 58 and 60 for reflecting portions of the first and second measuring beams 46 and 48 as reference beams 62 and 64. The reference optics are selected to be transmissive within the range of frequencies propagated by the interferometers 12 and 14. Although described in various embodiments herein as being included in the first and second supports 206 and 208, it is contemplated that the reference optics can be independent of the supports in some embodiments. Remaining portions of the measuring beams 46 and 48 propagate through the first and second supports 206, 208, and certain transverse sections of the remaining portions of the measuring beams 46 and 48 reflect from the opposite side surfaces 16 and 18 of the substrate 106 as test object beams 66 and 68.

Test object beam 66 combines with reference beam 62 at the reference surface 58 to form an interference pattern (not shown) registering differences between the first side surface 16 and the reference surface 58. Moreover, the test object beam 68 combines with the reference beam 64 at the reference surface 60 to form an interference pattern (not shown) registering differences between the second side surface 18 and the reference surface 60.

The reflected test object beam 66 and the reference beam 62 both propagate along a common optical pathway through the measurement arm 42 to the beam splitter 38, where at least portions of the beams 66 and 62 are directed (e.g., reflected) into a recording arm 78 of the upper interferometer 12. Similarly, the reflected test object beam 68 and the reference beam 64 both propagate along a common optical pathway through the measurement arm 44 to the beam splitter 40, where at least portions of the beams 68 and 64 are directed (e.g., reflected) into a recording arm 80 of the lower interferometer 14.

Referring again to FIG. 1A, within the recording arm 78, the interference patterns formed at the first reference surface 58 are imaged onto detector surface 82 of camera 86. Similarly, within the recording arm 80, the interference patterns formed at the second reference surface 60 are imaged onto detector surface 84 of camera 88. The detector surfaces 82 and 84 can include detector arrays for measuring beam intensity throughout a field of view encompassing the opposite side surfaces 16 and 18 of the substrate 106. The dual optics 50 and 52 can contribute to the formation of the referenced images onto the detector surface 82 and 84. However, the cameras 86 and 88 can include or be associated with imaging optics 74 and 76 for resizing or otherwise completing the imaging of the referenced images onto the detector surfaces 82 and 84.

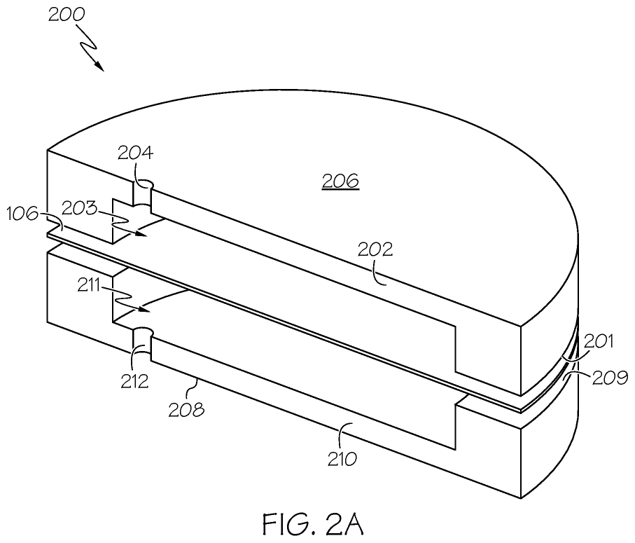

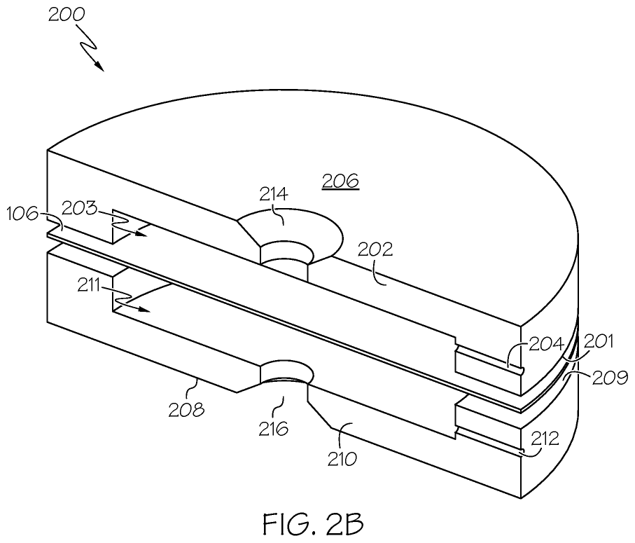

In FIGS. 1A and 1B, the first and second supports 206 and 208 are physically interconnected by to form a substrate holder 200 defining a measurement cavity therein. For example, the first and second supports 206 and 208 can be connected using techniques that do not deform or distort the Fizeau element or bearing lands, such as by bolting or adhering the supports together through precision surfaces, clamping mechanisms, or through other techniques known and used in the art. The substrate holder 200 protects and preserves the overall integrity of the optical reference cavity 108 formed by the two reference surfaces 58 and 60. An example substrate holder 200 is shown in FIGS. 2A and 2B. In particular, FIGS. 2A and 2B show a cross-sectional view of a substrate holder 200 including a substrate 106.

As shown in FIGS. 2A and 2B, the substrate 106 is positioned within the substrate holder 200 between the first support 206 and the second support 208. The first support 206 includes a first bearing land 201 and a first bearing base 202 that are arranged to form a first bearing pocket 203. Similarly, the second support 208 includes a second bearing land 209 and a second bearing base 210 that are arranged to form a second bearing pocket 211. The first support 206 and the second support 208 are positioned relative to one another such that the first bearing pocket 203 is opposed to the second bearing pocket 211, thereby forming a measurement cavity between the first support 206 and the second support 208.

In embodiments, the first support 206 further includes a first gas inlet 204 that is coupled to the first bearing pocket 203 and the second support 208 includes a second gas inlet 212 that is coupled to the second bearing pocket 211. Gas is supplied from a gas supply (not shown) to the first bearing pocket 203 and the second bearing pocket 211 through the first gas inlet 204 and the second gas inlet 212, respectively, to form a first and second air bearing in the measurement cavity. As used herein, the “air bearing” refers to the combination of the first or second bearing pocket and the corresponding first or second bearing land. In various embodiments, the air bearing supports the substrate 106 without contact between the substrate 106 and the first support 206 and the second support 208, as will be described in greater detail herein.

As set forth above, in various embodiments, the first support 206, the second support 208, or both the first support 206 and the second support 208 includes reference optics or metrology elements through which one or more interferometric or optical measurements can be taken. The reference optics can be form at least part of the first support 206 and/or the second support 208 (as shown in FIG. 2A), or can be coupled to or integrated with the first support 206 and/or the second support 208 (as shown in FIG. 2B). As shown in FIG. 2A, when the reference optics are Fizeau optics, the first support 206 and the second support 208 may be in the form of a wedge, in which one of the surfaces is angled at about 1 degree relative to an opposing surface. The angle is set such that the reflection from the sloped surface does not return to the camera and interfere with the test or reference beams. It should be appreciated that other designs for the reference optics can be employed, and optical measurements can be taken from one or both sides of the substrate 106.

In embodiments in which the reference optics or metrology elements are coupled to or integrated with the support, the support includes an aperture sized to receive the reference optics. For example, as shown in FIG. 2B, the first support 206 includes a first aperture 214 extending through the first bearing base 202 and the second support 208 includes a second aperture 216 extending through the second bearing base 210. Each of the first aperture 214 and the second aperture 216 are sized to receive the reference optics (not shown). In embodiments, the first support 206 and the second support 208 are coupled to the reference optics such that an airtight seal is formed between the reference optics and the corresponding first support 206 or second support 208. For example, o-rings or other types of seals may be disposed between the reference optics and the aperture to ensure a tight fit between the aperture and the reference optics, which enables the air pressure to be maintained within each of the bearing pockets. Reference optics and metrology elements that can be coupled to the first support 206 and/or the second support 208 include, but are not limited to, capacitance displacement probes, laser interferometers, and confocal probes. Enabling the reference optics to be removed from the substrate holder can, for example, provide additional design flexibility (e.g., flexibility regarding the positioning of gas inlets, the use of porous media, and the materials that may be used to form the supports) as well as enable the substrate holder to be used with a variety of metrological instruments to obtain a variety of measurements.

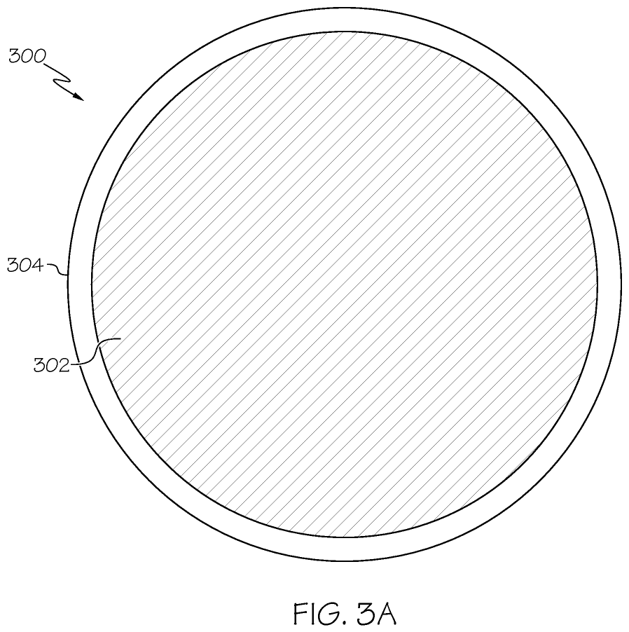

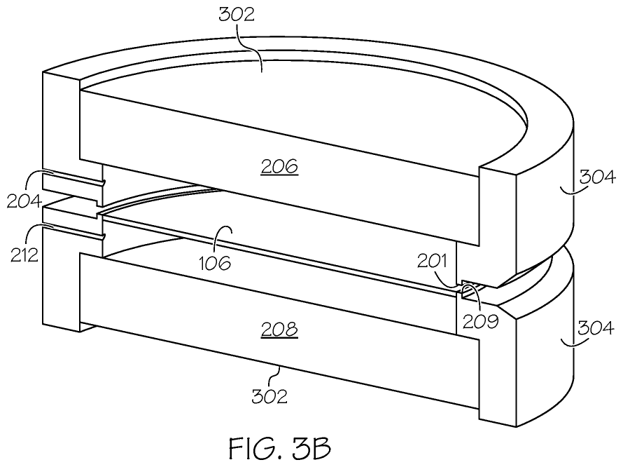

In various embodiments, at least part of the support may be formed from glass or another optically-transparent material. In some embodiments, such as the embodiment shown in FIG. 2A, the first bearing base 202 and/or second bearing base 210 can be a glass substrate, and the whole bearing base can be an optical reference. In some embodiments, the optical reference 300 can include a Fizeau wedge 302 mounted within a bezel 304 or other annular housing, as shown in FIGS. 3A and 3B. The bezel 304 can be formed from metal, such as aluminum or stainless steel, or another material that is sufficiently rigid to hold the Fizeau wedge 302 in place. An epoxy or other adhesive can be used to secure and seal the Fizeau wedge 302 within the bezel 304. In embodiments, such as the embodiment shown in FIG. 3B, a Fizeau wedge 302 forms the first bearing base 202 and the second bearing base 210 and a bezel 304 forms the first bearing land 201 and the second bearing land 209 of the corresponding first support 206 and second support 208.

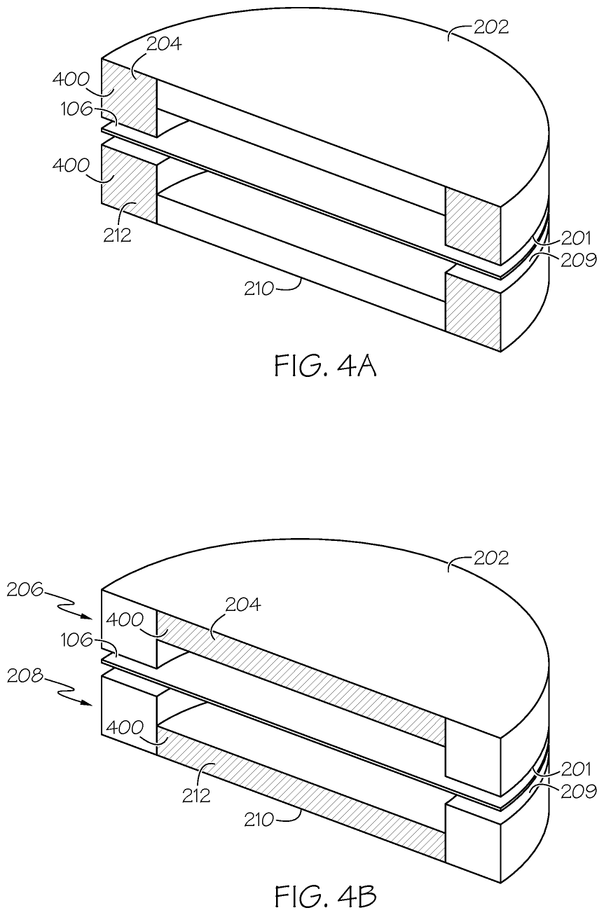

In embodiments, such as the embodiments shown in at least FIGS. 1B, 2A, 2B, and 3B, the first gas inlet 204 and the second gas inlet 212 may be in the form of one or more discrete bores in the corresponding first or second support 206, 208. In particular, the bores may open into the corresponding first bearing base 202 or second bearing base 210, as shown in FIGS. 1B and 2, or may open into the corresponding first bearing land 201 or second bearing land 209, as shown in FIG. 3B. However, in other embodiments, such as the embodiments shown in FIGS. 4A and 4B, the first gas inlet 204 and the second gas inlet 212 may be in the form of a porous medium 400.

As shown in FIG. 4A, in embodiments, the porous medium 400 is disposed within the first bearing land 201 and/or the second bearing land 209. In embodiments, the porous medium 400 is disposed within the first bearing base 202 and/or the second bearing base 210, as shown in FIG. 4B. The porous medium can be, by way of example and not limitation, graphite or porous carbon, or other machinable porous materials. In embodiments in which the gas inlets comprise porous media, the porous media apply gas pressure to the substrate 106 directly through the bearing lands (FIG. 4A), the bearing bases (FIG. 4B), or both. The porous medium can be used as (e.g., form) the bearing land, the bearing base, or a restrictor element fluidly coupled to the bearing land or bearing base. In embodiments, gas is provided to the porous medium via a plenum or gas line coupled to the porous medium, and diffuses through the porous medium to apply gas pressure to the substrate 106.

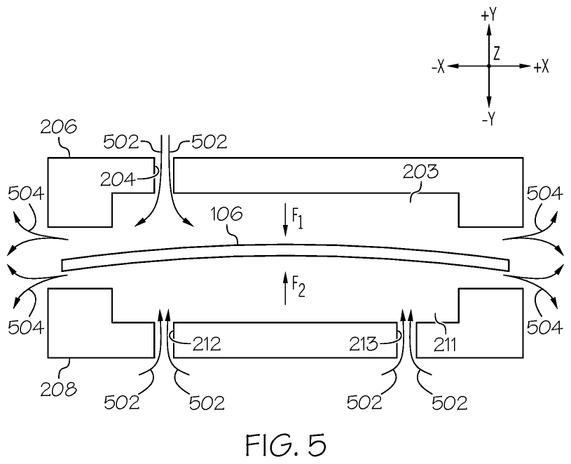

FIG. 5 is a cross-section of an example substrate holder 200 including a first gas inlet 204 in the first support 206 and a second gas inlet 212 in the second support 208. In the embodiment shown in FIG. 5, the second support 208 also includes a third gas inlet 213. Accordingly, it should be appreciated that each support can have one or more gas inlets, and, in some embodiments, the number of gas inlets in the first support 206 may differ from the number of gas inlets in the second support 208.

In various embodiments, regardless of whether the gas inlet is in the form of porous media or one or more discrete bores, gas is provided to the first bearing pocket 203 and the second bearing pocket 211 through the corresponding gas inlet to form an air bearing. The gas can be, by way of example and not limitation, compressed air, helium (He), an inert gas, such as nitrogen (N₂) or argon (Ar), or a combination thereof. Other gases can be used, provided they are clean and pressurized. The gas can be supplied to both the first and second gas inlets from a single gas supply, or each gas inlet may be coupled to its own gas supply, depending on the embodiment.

As shown in FIG. 5, the gas is supplied to the first bearing pocket 203 and the second bearing pocket 211 through the corresponding gas inlets 204, 212, and 213, as shown by arrows 502, and exhausted to atmosphere, as shown by arrows 504. Accordingly, in addition to providing support to the substrate 106, the flow of pressurized gas through the air bearing pushes particulates away from the substrate 106 and out of the measurement cavity, thereby keeping the substrate 106 free of contaminants.

The gas flowing through the first gas inlet 204 provides a first pressure force F₁ in the first bearing pocket 203 and the gas flowing through the second gas inlet 212 provides a second pressure force F₂ in the second bearing pocket 211. The particular values for each of the first pressure force F₁ and the second pressure force F₂ can vary depending on the specific embodiment and can depend at least on the mass of the substrate 106. In embodiments, each of the first pressure force F₁ and the second pressure force F₂ are selected to support the substrate 106 between the first support 206 and the second support 208 without contact between the opposite side surfaces 16 and 18 of the substrate 106 and the first support 206 and the second support 208. In some embodiments, the first pressure force F₁ is equal to the second pressure force F₂. In some embodiments, the first pressure force F₁ is different from the second pressure force F₂. For example, the first pressure force F₁ can be greater than the second pressure force F₂ or the first pressure force F₁ can be less than the second pressure force F₂, as is shown in FIG. 5.

In some embodiments in which the first pressure force F₁ is different from the second pressure force F₂, the difference is used to stiffen (i.e., increase the stiffness of) and/or deform the substrate 106, as shown in FIG. 5. In other words, the pressure differential between the first bearing pocket 203 and the second bearing pocket 211 can deform the substrate 106, thereby changing the shape of the cross-sectional area of the substrate 106. Without being bound by theory, this deformation of the substrate can increase the stiffness of the substrate and alter the natural frequency of the substrate to increase stability of the substrate. As an example, when the first pressure force F₁ is greater than the second pressure force F₂, the substrate 106 is deformed such that the cross-section of the substrate takes the general shape of an arc. The addition of the arc increases the stiffness of the substrate in the direction of the optical axis (e.g., in the direction of the Y-axis, as shown in FIGS. 1A, 1B, and 5).

The first natural frequency of the substrate can be represented by the following equation (1):

$${f}_{n} = \frac{1}{2 π} \sqrt{\frac{k}{m}} \qquad ( 1 )$$

where fₙ is the first natural frequency of the substrate (in hertz, Hz), k is the stiffness of the substrate (in Newtons per meter, N/m), and m is the mass of the substrate (in kilograms, kg). Accordingly, an increase in the stiffness k of the substrate shifts the natural frequency of the substrate. This shift in the natural frequency can, for example, decrease the excitation of the substrate and reduce or even eliminate non-contact vibrations induced by resonate frequencies in the environment, thereby increasing the stability of the substrate 106 within the substrate holder 200.

More specifically, vibrations from the external environment are transmitted as a time-dependent (e.g. oscillating) force to and through the substrate 106. Such forces are detrimental to the resolution of measurements made at the first and second surfaces 16 and 18 of the substrate 106 because they can cause motion of the substrate 106 relative to the first support 206 and/or second support 208. It is accordingly desirable to minimize transmission of vibrational force through the substrate 106.

Transmissibility

$$\vert \frac{x}{F} \vert$$

of a force within a system can be represented as a function of mass, stiffness, and damping according to the following equation (2):

$$\vert \frac{x}{F} \vert = \frac{1}{k \sqrt{{( 1 - \frac{m {w}^{2}}{k} )}^{2} + {( \frac{c w}{k} )}^{2}}} \qquad ( 2 )$$

where m is the mass of the system, k is the stiffness of the system, c is the viscous damping of the system, F is the magnitude of the external excitation force (e.g., force associated with external vibrations) applied to the system (also referred to as “input force”), w is the frequency of the external force applied to the system, and x is the displacement of the system in the direction of the optical axis (e.g., in the direction of the Y-axis as shown in FIGS. 1A and 1B). Accordingly, in various embodiments, the increased stiffness k of the substrate can change the natural frequency of the substrate 106 and increase the amount of energy (force) needed to excite (vibrate) the substrate 106.

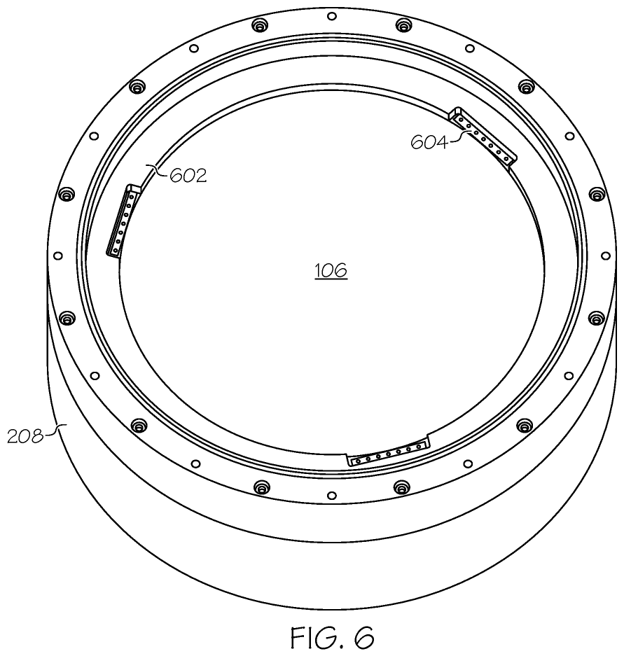

In embodiments, such as the embodiment shown in FIG. 6, the substrate 106 is radially constrained by a wafer holder 602. In other words, the wafer holder 602 limits movement of the substrate 106 within a plane (e.g., the X-Z plane in the FIGS.) normal to the optical axis (e.g., the Y-axis in the FIGS.), thereby preventing the substrate 106 from moving outside of the measurement cavity. The wafer holder 602 can be coupled to at least one of the first support 206 and the second support 208 in any suitable way. For example, the wafer holder 602 can be bolted or adhered to the second support 208, as shown in FIG. 6.

In the embodiment depicted in FIG. 6, the wafer holder 602 is coupled to the second support 208 and includes one or more wafer mounts 604 that are configured to receive the substrate 106. In the embodiment shown in FIG. 6, the wafer mounts 604 form a three-point mount that radially constrains the substrate 106 within the substrate holder 200. However, it is contemplated that the wafer holder 602 and/or the wafer mounts 604 can be otherwise configured. In embodiments, the wafer holder 602 obscures as little of the substrate 106 as possible. Regardless of the particular wafer mounts 604 and wafer holder 602 employed, in various embodiments, the substrate 106 is disposed in a “free state” or “quasi-free state” within the substrate holder 200. In other words, the first and second side surfaces 16 and 18 of the substrate 106 are not mounted to, in contact with, or pressed against another structure, such as the wafer holder 602.

Returning again to FIG. 1A, during measurements in which the substrate 106 is illuminated by portions of the measuring beams 46 and 48, the substrate 106 is supported and stabilized within the substrate holder 200 to maintain a constant spacing and orientation between the opposite side surfaces 16 and 18 of the substrate 106 and the reference surfaces 58 and 60 of the supports 206 and 208. Thus, the interference patterns formed within the upper interferometer 12 and the lower interferometer 14 are minimally affected by disturbances that affect the substrate holder 200 as a whole. Moreover, at least one of the supports (e.g., the first support 206) is disconnected from the remainder of its measurement arm (e.g., measurement arm 42 in FIG. 1). For example, the housing 51 of the measurement arm 42 has no direct physical connection to the first support 206 independent of the mounting as part of the substrate holder 200. Instead, the housing 51 of the measurement arm 42 is mounted via a flange 120 and collar 122 to a base 124, which preferably has a substantial mass (e.g., a granite slap or steel plate) to isolate the upper interferometer 12 from environmental disturbances. The substrate holder 200, however, is connected through a collar 126 to the housing 53 of the measurement arm 44, and the housing 53 of the measurement arm 44 is connected through a flange 128 to the base 124. By separating the support 206 (and, accordingly, one of the optical references) from the remainder of its measurement arm 42, the two supports 206, 208 are not subject to different movements, transfers, or other disturbances otherwise associated with their different measurement arms 42 and 44. It is contemplated that the substrate holder 200 can be disconnected from both of the measurement arms 42, 44 in embodiments. The gas flow across the bearing land creates a cushion of air in which to float the substrate. As a result, the substrate is not mechanically attached to either interferometer. In embodiments, shear damping created between the gas, the bearing land, and the substrate help to mitigate vibrations. Additionally, the differential pressure created by the air bearings on opposing surfaces of the substrate can deform the substrate and, as a result, increase the substrate stiffness, shifting the natural frequency of the substrate.

In various embodiments described herein, the substrate holder 200 enables simultaneous measurement of first and second surfaces of a substrate while stabilizing the substrate to ensure precision measurements by providing an air bearing that supports and stabilizes the substrate. In some embodiments, 99.3% or more of a substrate's surface can be measured at once with stabilization in the single digit nanometers during measurements. Moreover, the air bearing can be used to deform the substrate in a repeatable and predictable way, such as may be used to counter substrate sag due to gravity and/or artificially increase the stiffness of the substrate, thereby shifting the natural frequency of the substrate.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A substrate holder for use with an interferometer, the substrate holder comprising:
a first support comprising a first bearing land and a first bearing base arranged to form a first bearing pocket and a first gas inlet fluidly coupled to the first bearing pocket; and
a second support comprising a second bearing land and a second bearing base arranged to form a second bearing pocket and a second gas inlet fluidly coupled to the second bearing pocket, wherein:
the first support and the second support are positioned relative to one another such that the first bearing pocket is opposed to the second bearing pocket thereby forming a measurement cavity between the first support and the second support;
at least one of the first support and the second support comprises reference optics through which one or more interferometric or optical measurements can be taken; and
gas supplied to the first bearing pocket and gas supplied to the second bearing pocket form an air bearing in the measurement cavity for supporting a substrate in the measurement cavity without contact between the substrate, the first support, and the second support.

2. The substrate holder according to claim 1, wherein at least one of the first gas inlet and the second gas inlet comprises a porous medium.

3. The substrate holder according to claim 2, wherein the porous medium is disposed within the corresponding first or second bearing land.

4. The substrate holder according to claim 2, wherein the porous medium is disposed within the corresponding first or second bearing pocket.

5. The substrate holder according to claim 1, wherein at least one of the first gas inlet and the second gas inlet comprises one or more discrete bores in the corresponding first or second support.

6. The substrate holder according to claim 5, wherein the one or more discrete bores open into the corresponding first or second bearing land.

7. The substrate holder according to claim 5, wherein the one or more discrete bores open into the corresponding first or second bearing base.

8. The substrate holder according to claim 1, further comprising a wafer holder positioned within the measurement cavity and coupled to at least one of the first support and the second support.

9. The substrate holder according to claim 1, wherein the first support and the second support comprise reference optics through which one or more interferometric or optical measurements can be taken.

10. The substrate holder according to claim 1, wherein the reference optics comprise Fizeau elements.

11. The substrate holder according to claim 1, wherein the gas flowing through the first gas inlet provides a first pressure force in the first bearing pocket, the gas flowing through the second gas inlet provides a second pressure force in the second bearing pocket, and the first pressure force is different from the second pressure force.

12. The substrate holder according to claim 11, wherein the difference between the first pressure force and the second pressure force stiffens a substrate positioned between the first air bearing and the second air bearing.

13. An interferometer comprising the substrate holder according to claim 1.

14. The interferometer according to claim 13, wherein the interferometer makes measurements through one of the first and second supports.

15. The interferometer according to claim 13, wherein the interferometer is a compound interferometer and makes measurements through the first and second supports.

16. A method comprising:
positioning a substrate within a substrate holder, the substrate holder comprising:
a first support comprising a first bearing land and a first bearing base arranged to form a first bearing pocket and a first gas inlet coupled to the first bearing pocket; and
a second support comprising a second bearing land and a second bearing base arranged to form a second bearing pocket and a second gas inlet fluidly coupled to the second bearing pocket; wherein:
the first support and the second support are positioned relative to one another such that the first bearing pocket is opposed to the second bearing pocket thereby forming a measurement cavity between the first support and the second support;
at least one of the first support and the second support comprises reference optics through which one or more interferometric or optical measurements can be taken;
supplying gas to the first bearing pocket and the second bearing pocket to form an air bearing in the measurement cavity for supporting the substrate in the measurement cavity without contact between the substrate, the first support, and the second support; and
making one or more interferometric or optical measurements through the first support, the second support, or the first and second supports.

17. The method according to claim 16, wherein the gas flowing through the first gas inlet provides a first pressure force in the first bearing pocket, the gas flowing through the second gas inlet provides a second pressure force in the second bearing pocket, and the first pressure force is different from the second pressure force.

18. The method according to claim 17, wherein the difference between the first pressure force and the second pressure force stiffens the substrate.

19. The method according to claim 16, wherein the first support and the second support comprise reference optics, and wherein making the one or more interferometric or optical measurements comprises making the one or more interferometric or optical measurements through the reference optics.

20. The method according to claim 19, wherein the reference optics comprise Fizeau elements.
